(19) United States
(12) Patent Application Publication
(10) Pub. No.: US 2010/0289429 A1
(43) Pub. Date: Nov. 18, 2010

(54) METHODS OF AND DRIVING UNITS FOR DRIVING A GAS DISCHARGE LAMP

(75) Inventors: Jens Pollmann-Retsch, Eindhoven (NL); Johannes Baier, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,447

(22) PCT Filed: Jul. 26, 2007
(86) PCT No.: PCT/IB07/52968

§ 371 Date: May 6, 2010

(30) Foreign Application Priority Data
Aug. 10, 2006 (EP) 06118716.7

(51) Int. Cl. H05B 41/36

(52) U.S. Cl. 315/307

(57) ABSTRACT

Methods of driving a gas discharge lamp (1). In a first method, a value of voltage (Ul) across the gas discharge lamp (1) is determined, then a correction function (Kd) representing the dependency of light flux on a discharge arc length (d) is applied to calculate a required lamp power value (Pr) for a target light flux value (Ul). Finally, the gas discharge lamp (1) is operated according to the required lamp power value (Pr). In a second method, a value of voltage (Ul) across the gas discharge lamp (1) and a value of pressure (pl) inside the gas discharge lamp (1) are determined, then a correction function (Kp) representing the dependency of light flux on a discharge arc length (d) is applied to calculate a required lamp pressure value (pr) for a target light flux value by using the lamp voltage value (Ul) and the lamp pressure value (pl). Finally, the gas discharge lamp (1) is operated according to the required lamp pressure value (pr). Furthermore, the invention relates to appropriate driving units (4, 58) for driving a gas discharge lamp (1) and to an image rendering system, particularly a projector system, comprising gas discharge lamps (1) and such driving units (4, 58).

This invention relates to methods of driving a gas discharge lamp. Furthermore, the invention relates to appropriate driving units for driving a gas discharge lamp and to an image rendering system, particularly a projector system, comprising gas discharge lamps and such driving units.

Gas discharge lamps, particularly high pressure gas discharge lamps, are commonly used as a light source for applications like head lights of automobiles, illumination of buildings, or video projection systems. In general, these gas discharge lamps comprise an envelope or a chamber which consists of material withstanding high temperatures, for example quartz glass. From opposing sides, electrodes protrude into this envelope. The electrodes are made of an electrically conductive material, often including a larger portion of tungsten. The chamber contains a filling consisting of one or more rare gases, and, in the case of a mercury vapour discharge lamp, mainly of mercury. By applying a high ignition voltage across the electrodes, a light arc is created between the tips of the electrodes. After the light arc has been established, a voltage lower than the ignition voltage can be applied to maintain the light arc. In general, this voltage could be either a direct current type voltage (“DC type”) or an alternating current type voltage (“AC type”). However, it is a common practice to operate a gas discharge lamp with an AC type voltage, as this mode leads to a more even load of the electrodes compared to the DC type mode.

Nevertheless, even in the AC type operation mode, the shape of the electrodes and thereby the length of the discharge arc typically vary during the operation of the lamp. Those variations include short term variations, long term, or even life time variations, and often also variations that are caused by a specific operation mode of the gas discharge lamp. The variations of the shape of the electrodes can be explained by the fact that the electrodes do reach relatively high temperatures when the gas discharge lamp is operated at or close to its nominal power rating. Those high temperatures are causing at least a partial melting of the electrode material that can result in a change of the shape of the electrode. Furthermore, especially when an electrode is operated as an anode, evaporation of electrode material might occur at the spot where the light arc attaches to the electrode. The vaporization is often accompanied by a condensation of material at the electrodes, especially when the direction of the current supplied to the gas discharge lamp is switched, i.e. when an electrode is switched from the anode to the cathode mode. The repetition of this evaporation-condensation cycle often leads to the formation of protrusions on the tip of the electrodes which essentially reduce the length of the discharge arc. In addition, a change in the operating conditions of the gas discharge lamp might also introduce a change in the shape of the electrodes and the length of the discharge arc. For example, if a gas discharge lamp is switched from a nominal power level into a dimmed mode by reducing the electrical power supplied to the lamp, the temperature inside the chamber and of the electrodes falls. The reduced temperature then could lead to condensation of material on the electrodes, thereby altering the length of the discharge arc. In addition, often modes of operation are applied to intentionally change the shape of the electrodes or the length of the discharge arc. For example, U.S. Pat. No. 5,608,294 describes a circuit arrangement that promotes the deposition of material on the surface of the electrodes, whereas WO 2005/062684 A1 discloses a method and a circuit arrangement that is adjusting the frequency of the AC type voltage being supplied to the gas discharge lamp to prevent that the length of the gas discharge arc becomes too short.

A problem associated with these variations of the arc length is that depending on the arc length, the light flux generated by the gas discharge lamp will vary as well. Obviously, this problem represents a drawback for manyof the applications of gas discharge lamps, like their use in head lights of automobiles. It is particularly undesirable when a gas discharge lamp is used as a light source in an image rendering system since the user of the system will notice such variations as disturbing changes in the brightness of the rendered picture or video. This drawback is aggravated by the fact that for image rendering systems an optimized performance of the optical system can only be achieved by lamps with very short discharge arcs. Unfortunately, these ultra short arc lamps are characterized by a strong dependency of the light flux on the length of the discharge arc.

Therefore, it is an object of the present invention to provide methods of driving a gas discharge lamp to maintain a desired target light flux even if the length of the discharge arc is changing, and to provide appropriate driving units which can be used, for example, in an image rendering system to avoid undesirable variations of the light flux as described above.

To this end, the present invention provides a first method of driving a gas discharge lamp, whereby a value of voltage across the gas discharge lamp is determined. Subsequently, a correction function representing the dependency of light flux on a discharge arc length is applied to calculate a required lamp power value for a target light flux value by using the determined lamp voltage value. The gas discharge lamp is then operated in accordance with the calculated required lamp power value.

In a second method according to this invention, a value of pressure inside the gas discharge lamp is determined in addition to the lamp voltage value. Subsequently, a correction function representing the dependency of light flux on a discharge arc length is applied to calculate a required lamp pressure value for a target light flux value by using the determined lamp voltage value and the determined lamp pressure value. Then, the gas discharge lamp is operated according to the calculated required lamp pressure value.

By using either of these two methods, it is possible to operate a gas discharge lamp such that it delivers a stable flux of light even if the length of the discharge arc is changing. Particularly for image rendering purposes, a stable light flux beneficially contributes to the projection quality as experienced by the user.

In general, many state of the art lamp driving methods are characterized by a procedure, in which the electrical power being supplied to the gas discharge lamp is adjusted to meet a target lamp power value. Contrary to this, the methods according to the invention are controlling the operation of a gas discharge lamp such that a pre-defined target light flux is achieved. This is important, because a well controlled light flux is in general a key property for any kind of illumination purpose, especially for image rendering systems. Since the methods are not limited to a single target light flux value, they can be beneficially applied for gas discharge lamps that must be operated at different levels of light output. Such a requirement is typically given for image rendering systems, since they should be able to dim the light output for darker images or video scenes. In those cases, the methods according to the invention provide the possibility to accurately adjust the light output, since the influence of the discharge arc length on the light, output is taken into account. Furthermore, with the availability of the methods according to the invention, the desirable use of ultra short arc gas discharge lamps will become less critical. Those lamps are characterized by a discharge arc length of around 1 mm or even below 1 mm. The strong dependence of the light flux on the arc length, which is common for those lamps, can be compensated in a simple fashion according to the disclosed methods.

The invention beneficially makes use of parameters, like the lamp voltage or the lamp pressure, to determine corrections for the arc length variations. In general, those parameters can be obtained more easily than the length of the discharge arc itself. In fact, in many cases it might be almost impossible to directly measure or determine the actual discharge arc length.

A first driving unit corresponding to the first method comprises a voltage determination unit, a power calculation unit, and a power control unit. The power calculation unit calculates a required lamp power value for a target light flux value using the lamp voltage value and a correction function, whereby the correction function represents the dependency of light flux on a discharge arc length. The power control unit then operates the gas discharge lamp according to the calculated required lamp power value. Since a typical state of the art lamp driving unit already comprises modules or units for obtaining a lamp voltage, for performing calculations, and for controlling the electrical power being supplied to the gas discharge lamp, a driving unit according to the invention can particularly advantageously be obtained by simply providing an existing driving unit with suitable software modules or, for example, by upgrading its processor or software code storage unit.

A second driving unit corresponding to the second method comprises a voltage determination unit, a pressure determination unit, a pressure calculation unit, and a pressure control unit. The voltage determination unit and the pressure determination unit determine a lamp voltage value and a lamp pressure value, respectively. The pressure calculation unit calculates a required lamp pressure value for a target light flux value using the lamp voltage value, the lamp pressure value, and a correction function, whereby the correction function represents the dependency of light flux on a discharge arc length. The pressure control unit then operates the gas discharge lamp according to the calculated required lamp pressure value.

The dependent claims and the subsequent description disclose particularly advantageous embodiments and features of the invention.

It has been observed that the voltage value U_{L} across the gas discharge lamp can be essentially described or at least approximated with sufficient accuracy by the following relation:

U_{L}=U_{fall}+aₚ·d (1)

where U_{fall} is the electrode fall, aₚ is a coefficient depending on the pressure inside the chamber of a gas discharge lamp, and d is the length of the discharge arc. For typical ultra high pressure gas discharge lamps, U_{fall} assumes a constant value, normally in between 16V and 18V. By re-arranging equation (1), the length of the discharge arc d can be expressed by a fraction, for which fraction the numerator is given by a subtraction of the lamp electrode fall value U_{fall} from the lamp voltage value U_{L}, and for which fraction the denominator is given by a lamp pressure dependent factor aₚ:

d=(U_{L}−U_{fall})/aₚ (2)

Furthermore, in many cases, the pressure inside the chamber of the gas discharge lamp essentially does not vary within a certain range of arc lengths or within a short time interval. Consequently, in a particular embodiment of this invention, it is assumed that the lamp pressure remains constant. Thereby, according to equation (2), the arc length d can be calculated simply by determining the lamp voltage U_{L}, since U_{fall} and aₚ are constant values in this case.

According to the publication SPIE Vol. 5740, pp. 12-26, 2005 by U. Weichmann et al., a light flux Φ collected from a general gas discharge can be described by the following relation:

Φ=η_{refl}·η_{coll}·ηₑₗₑ·P (3)

where η_{refl} is the reflectivity of a light reflector arranged in the proximity of the light arc, ηₚₗₐₛₘₐ is the intrinsic efficacy of the gas plasma discharge, η_{coll} is the collection efficiency of the light arc inside a given collecting etendue E, ηₑₗₑ is the so-called electrical efficiency, and P is the electrical power being supplied to the gas discharge lamp. The intrinsic efficacy ηₚₗₐₛₘₐ is a constant parameter and has, for example, a typical value of around 88 lm/W for a Hg-discharge within ultra high pressure lamps. Out of the five factors on the right hand side of equation (3), only, η_{coll} and ηₑₗₑ are depending on the discharge arc length d. Here, η_{coll} essentially can be described by a trigonometric arc tangent of a fraction of the collecting etendue E and a 2^{nd} order polynomial of the discharge arc length d:

η_{coll}=2·π⁻¹ atan [E/3.8·d²+0.9·d+0.8)] (4)

The electrical efficiency ηₑₗₑ can be expressed by the following equation:

η^{ele}=aₚ·d/U^{L} (5)

By using equations (4) and (5) to replace η_{coll} and ηₑₗₑ within equation (3), the light flux Φ can be determined by the following equation:

Φ=η_{refl}·ηₚₗₐₛₘₐ·2·π⁻¹ atan [E/3.8·d²+0.9·d+0.8)]·aₚ·d·U_{L}⁻¹P (6)

In accordance with the invention, equation (6) can be put to use for calculating a lamp power value P_{R} which is required to obtain a given target light flux Φ_{T}:

P_{R}(U_{L},d)=Φ_{T}/K_{d}(U_{L},d) (7)

where the correction function K_{d} is a function of U_{L} as well as d, and is describing the dependency of the light flux Φ on the discharge arc length d given by:

K_{d}(U_{L},d)=η_{refl}·ηₚₗₐₛₘₐ·2·π⁻¹ atan [E/(3.8·d²+0.9·d+0.8)]·aₚ·d·U_{L}⁻¹ (8)

Hereby, according to the invention, the correction function K_{d} is proportional to an arc tangent (atan) of a function of the collecting etendue E and the arc discharge length d. The polynomial coefficients (3.8, 0.9, and 0.8) are used as an example for the methods according to the invention. Without leaving the scope of the invention, e.g., a different functional dependence of K_{d} on U_{L} and d or a different set of values for the polynomial coefficients might be applied, depending on the actual lamp type used with this invention.

As already explained above, the discharge arc length d can be expressed by a function of the lamp voltage U_{L}, like for example as given by equation (2). This allows simplifying equation (8) such that K_{d} is only a function of the lamp voltage U_{L} as described by equation (9):

K_{d}(U_{L})=η_{refl}·ηₚₗₐₛₘₐ·2·π⁻¹ atan [E/(3.8·U_{d}²/aₚ²+0.9·U_{d}/aₚ+0.8)]·aₚ·U_{d}·U_{L}⁻¹ (9)

whereby a voltage difference U_{d} is given by:

U_{d}=U_{L}−U_{fall} (10)

In accordance with the invention, by employing equation (9), equation (7) can be simplified such that P_{R} can be obtained solely from the lamp voltage U_{L}, since all other parameters are constant, as outlined above. Hence, P_{R} is given by:

P_{R}(U_{L})=Φ_{T}/K_{d}(U_{L}) (11)

Based on equation (11), it is possible to operate a gas discharge lamp by a method according to the invention, such that the variations of the light flux caused by arc length variations can be compensated. Thereby, an essentially constant light flux is achieved, without the complexity to obtain the discharge arc length d directly.

In a preferred embodiment of the invention, the required power value P_{R} of equation (11) is calculated by using a mathematical approximation. Hereby, the relatively complex calculation, including an arc tangent function as shown in equation (9), could be simplified. Such a simplification can, for example, ease the realization of the disclosed methods within a lamp driving unit, because these driving units often do not provide the ability to perform complex calculations, like trigonometric functions. In a particularly preferred embodiment, the mathematical approximation is an algebraic function of the lamp voltage U_{L}.

In a further, particularly preferred embodiment, the algebraic function for calculating the required lamp power value P_{R} is an n-th order polynomial function of the lamp voltage U_{L} which may be described by the following equation:

P_{R}(U_{L})=cₙ·U_{L}ⁿ+cₙ₋₁·U_{L}ⁿ⁻¹+ . . . +c₂·U_{L}²+c₁·U_{L}+c₀ (12)

where n is a positive, natural number and cₙ, cₙ₋₁ . . . c₂, c₁, c₀ are polynomial coefficients. These polynomial coefficients might depend on parameters like the collecting etendue E, the fall voltage U_{fall}, the reflectivity η_{refl}, the intrinsic efficacy ηₚₗₐₛₘₐ and the target light flux Φ_{T}. In an especially preferred embodiment of the invention, the polynomial function is a 2^{nd} order polynomial, i.e. n=2 within equation (12).

In a further embodiment of the invention, the correction function K_{d} as given by equation (9) or the above described approximations, like the approximation given by equation (12), might be stored in a table-like format. For example, for a given set of lamp voltage values U_{L}, such a table—often called ‘look-up table’ or LUT-would provide a required lamp power value P_{R} for each of the values within the given set of lamp voltage values. In case a determined lamp voltage value U_{L} is not stored within the table, suitable approximations known to technical experts can be applied to determine a required lamp power value P_{R}.

According to the invention, the light flux generated by the discharge lamp can also be controlled and stabilized by controlling the lamp pressure. In this case, according to a widely accepted model of discharge lamp operation, a linear dependence of the factor aₚ on the actual lamp pressure p_{L}, is applied:

aₚ=a·p_{L} (13)

where a is a constant parameter. Accordingly, by using equation (13) to replace aₚ within equation (2), the length of the discharge arc d can be determined once the lamp voltage U_{L} and the lamp pressure p_{L} have been obtained:

d=(U_{L}−U_{fall})/a·p_{L} (14)

With the linear dependence of aₚ, on the lamp pressure, the electrical efficiency ηₑₗₑ according to equation (5) can be expressed as follows:

ηₑₗₑ=a·p_{R}·d/U_{L} (15)

where p_{R} is the lamp power value required for a target light flux Φ_{T}.

Re-arranging equation (2) leads to:

U_{L}=U_{fall}+a·p_{R}·d (16)

allowing to replace U_{L} within equation (15) such that ηₑₗₑ is given by:

ηele=[1+U_{fall}/(a·p_{R}·d)]⁻¹ (17)

which can be applied to replace ηₑₗₑ within equation (3) so that the lamp pressure value p_{R} required to achieve a preset target light flux Φ_{T} is given by:

p_{R}=Φ_{T}·U_{fall}·[a·d·(η_{refl}·ηₚₗₐₛₘₐ·η_{coll}P−Φ_{T})]⁻¹ (18)

Hereby, the correction function Kₚ for obtaining the required lamp pressure value p_{R} according to the invention actually represents a function Kₚ(Φ_{T}, d) which is depending on the target light flux Φ_{T}, and the arc length d. Even though equation (18) comprises the discharge arc length d as a parameter and the collection efficiency η_{coll} also depends on the discharge arc length, d can be eliminated as a parameter from function Kₚ by applying the relation established by equation (14). This can be done, since the discharge arc length d can be assumed to stay constant during the usually short time when the lamp pressure p_{L} is adapted to the new target value p_{R}. Hence, the correction function Kₚ finally depends on the target light flux (Φ_{T}, the lamp voltage value U_{L}, and the lamp pressure value p_{L}:

p_{R}=Kₚ(Φ_{T},U_{L},p_{L}) (19)

In many cases, the chamber of the gas discharge lamp is hermetically sealed. Therefore, the pressure inside the gas discharge lamp is only adjustable in an ‘indirect’ fashion, for example by changing the operation mode of the gas discharge lamp. A variation of the temperature of the gas discharge lamp can also have an impact on the pressure, because the pressure in the lamp is determined by the temperature of the coldest spot inside the discharge chamber. Accordingly, in another preferred embodiment of the invention, the pressure inside the gas discharge lamp is controlled by means capable of changing the temperature of the gas discharge lamp such that the gas discharge lamp is operated according to the required lamp pressure value. Those means for adjusting the temperature might include any kind of heating or forced cooling unit placed at or in close proximity to the gas discharge lamp. For example, a ventilator can be arranged next to the lamp such that the air flow generated by the ventilator is passing by the gas discharge lamp. By controlling the operation of the ventilator, the temperature of the gas discharge lamp can be varied, which finally leads to the desired control of the pressure inside the gas discharge lamp. Another way to accomplish a temperature variation may be a change of the power input into the lamp; this method, however, is then closely related to the power-control method described above.

Similar to the control of the pressure inside the gas discharge lamp, it is often not possible to directly determine the actual lamp pressure. Therefore, in another preferred embodiment of the invention, the pressure is determined by a spectral analysis of the light delivered by the gas discharge lamp. For example, for high-pressure mercury discharge lamps, the pressure inside the chamber of the gas discharge lamp can be derived from the width of the 546.1 nm spectral line.

Other objects and features of the present invention will become apparent from the following detailed descriptions considered in conjunction with the accompanying drawings. It is to be understood, however, that the drawings are designed solely for the purposes of illustration and not as a definition of the limits of the invention.

In the figures, like references denote the same objects throughout.

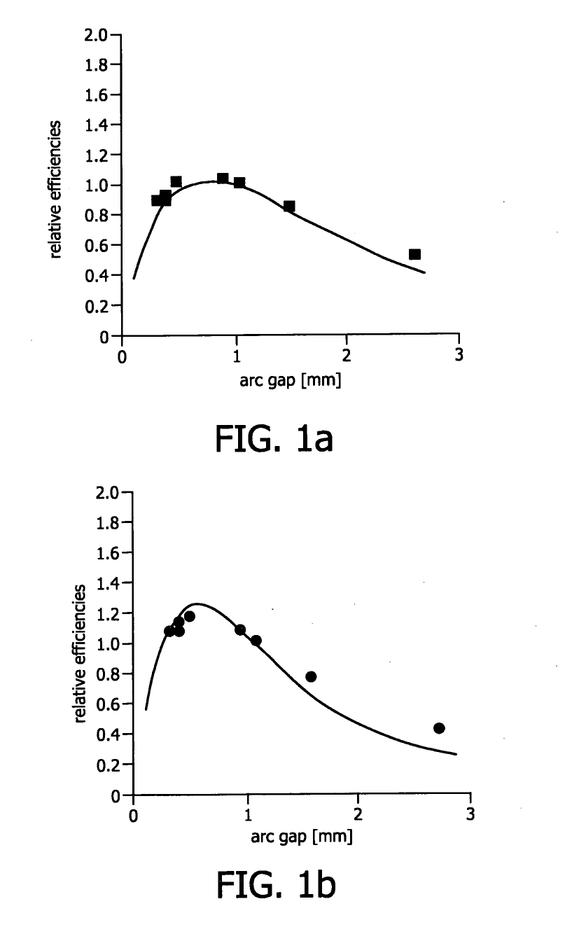

FIGS. 1a and 1b show two examples of measurements and the corresponding modelling, illustrating the dependency of the relative light flux collection efficiency on the length of the discharge arc;

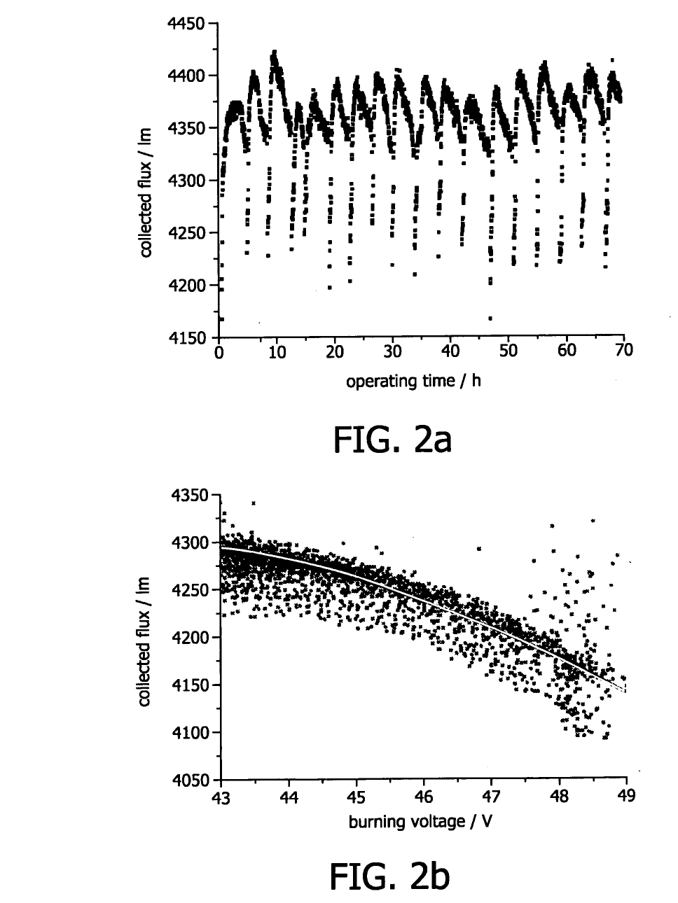

FIGS. 2a and 2b show measurement results for the collected light flux of a gas discharge lamp which is operated without a compensation for variations of the length of the discharge arc;

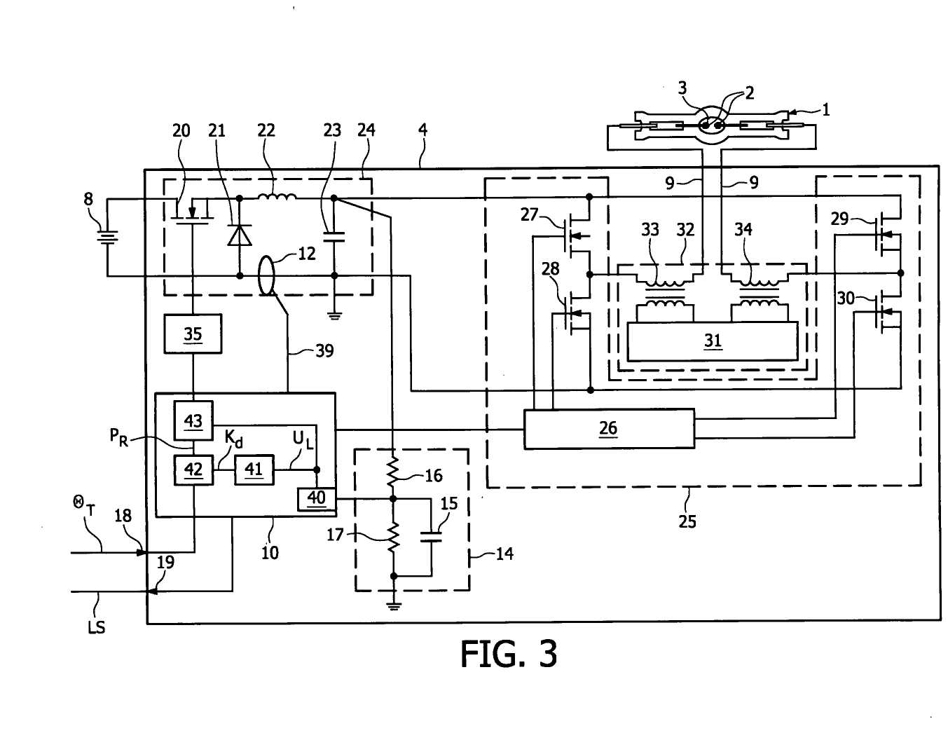

FIG. 3 shows a gas discharge lamp and a block diagram of a possible realization of a driving unit according to the invention;

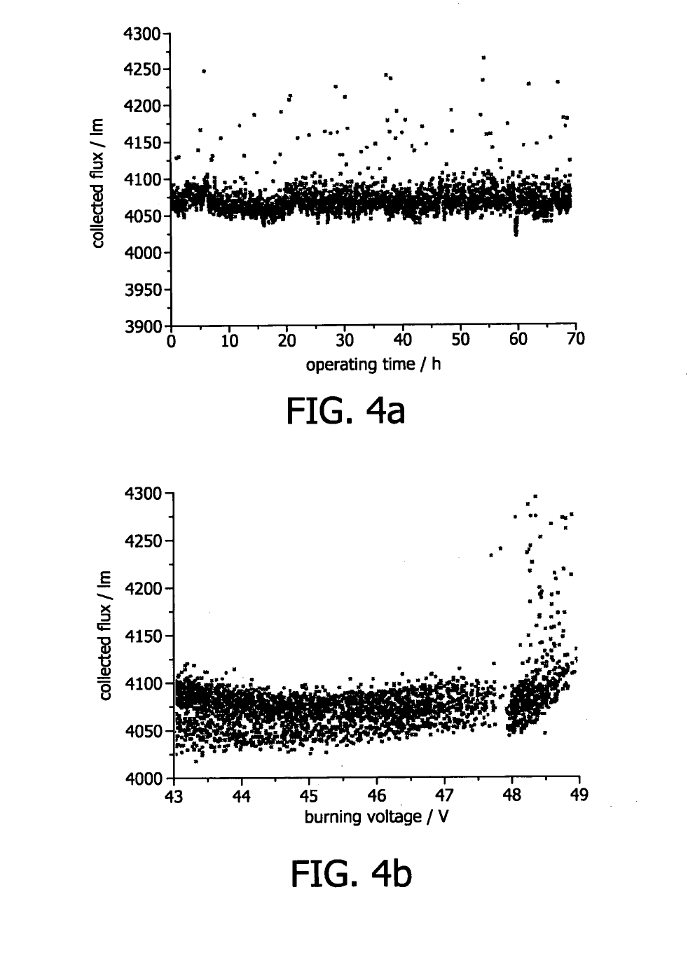

FIGS. 4a and 4b show measurement results for the collected light flux of a gas discharge lamp which is operated by a method according to the invention;

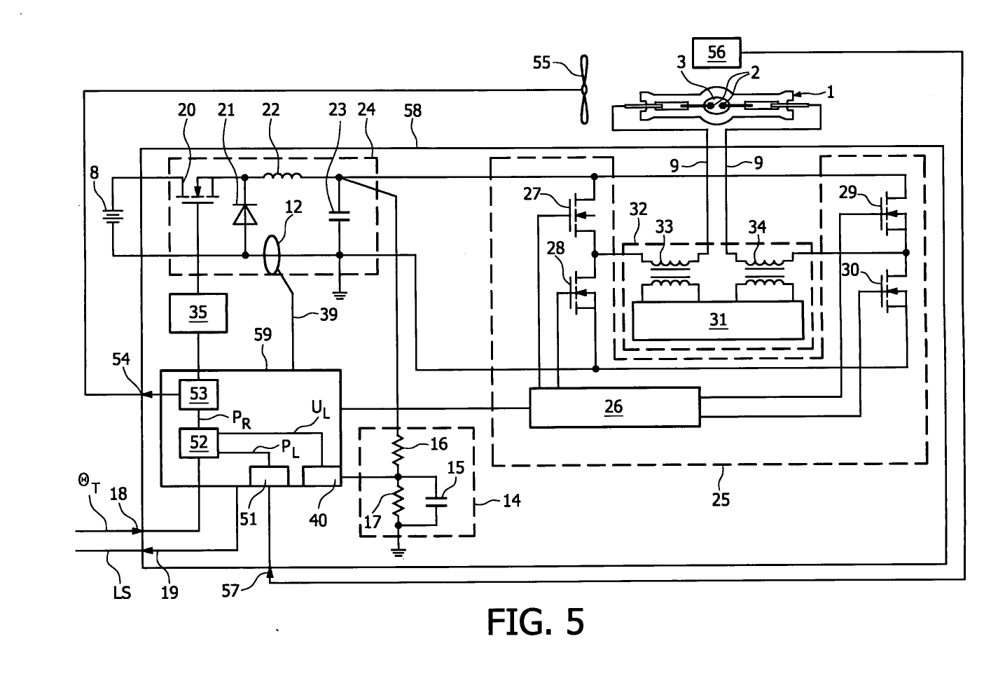

FIG. 5 shows a gas discharge lamp and a block diagram of a further possible realization of a driving unit according to the invention.

The dimensions of the objects in the figures have been chosen for the sake of clarity and do not necessarily reflect the actual relative dimensions.

FIG. 1a and 1b are excerpts of the publication J. Phys. D: Appl. Phys. 38, pp. 2995-3010, 2005 by G. Derra et al. It shows two examples of measurements and the corresponding modelling, illustrating the dependency of the relative light flux collection efficiency on the length of the discharge arc. Measurement results are illustrated by the rectangular dots whereas the corresponding models are represented by the solid lines. In FIG. 1a, the results are shown for an ultra high pressure (UHP) gas discharge lamp and for a collecting etendue E of 13 mm²sr, whereas FIG. 1b depicts the results for the same lamp and for a collecting etendue E of 5 mm²sr. In both cases, it can be seen that the light flux collected from the lamps strongly depends on the arc discharge length. Furthermore, this dependency is non-linear. The light flux has a local maximum of around or below 1 mm. In other words, the collected light flux does not increase monotonically with a decreasing length of the discharge arc. Therefore, the two examples justify the necessity to apply appropriate methods and corresponding driving units for compensating the impact of the arc length variations on the light flux, if a stable light flux is required. Furthermore, as can be seen in FIG. 1a and FIG. 1b, the collected light flux for the smaller collecting etendue E exhibits a much stronger dependence on the discharge arc length. Even little variations of the gas discharge length will lead to large changes of the light flux, especially around the maximum of the collected light flux. Therefore, methods and driving units according to the invention are particularly beneficial for achieving a stable light flux if newer gas discharge lamps with relatively short discharge arc length are used.

FIGS. 2a and 2b show measurement results for the collected light flux of a gas discharge lamp which is operated without a compensation for variations of the length of the discharge arc. In FIG. 2a the progression of the collected light flux for a period of approximately 70 hours of operating time is given. Obviously, the light flux varies by more than 5%. This is due to the changes of the shape of the electrodes as described earlier when operated with an alternating voltage. In addition, especially the larger variations that occur approximately every four hours are caused by a special operating scheme applied in this case. This scheme is disclosed in the above-mentioned patent application WO 2005/062684 A1. According to this patent application, the frequency of the current supplied to the gas discharge lamp is reduced if the voltage across the gas discharge lamp is falling below a certain threshold value, as this indicates that the electrode gap or discharge arc length has become too small. As a result of the reduced frequency, material on the electrodes, especially on the tips of the electrodes, will be removed due to an increased heating of the electrodes. However, the subsequent increase of the discharge arc length leads to a sudden increase in the collected light flux followed by a slower decrease. Those regularly occurring steep jumps in light flux can be clearly seen in FIG. 2a.

In FIG. 2b it is shown how the collected light flux depends on the voltage supplied to the gas discharge lamp. The larger variations that can be seen between approximately 48V and 49V are explained by the fact that the driving unit still supplied a current value that was appropriate for smaller discharge arc gaps (and hence lower lamp voltages) when the arc gap suddenly increased due to the special operation mode. Thus, the power level was too high for a limited period of time, until the slow power-control of the driving unit eventually stabilized the power again at the desired value. Beside the measurement results indicated by the rectangular dots, FIG. 2b also shows a line. This line follows the light flux that could be expected when applying the above described equations, especially equations (3), (4), and (5) in conjunction with the assumption that the lamp pressure remains constant. It can be seen that the line represents a relatively good model for the measurement results. Obviously, these equations and the assumption of a constant light pressure are sufficient to accurately predict the collected light flux of a gas discharge lamp. Such a prediction is achieved by simply determining the voltage across the lamp and applying appropriate methods and calculations according to the invention which take into account the dependency on the discharge arc length.

FIG. 3 shows a gas discharge lamp 1 and a block diagram of a possible realization of a driving unit 4 according to the invention.

The driving unit 4 is connected via connectors 9 with the electrodes 2 inside the arc tube 3 of the gas discharge lamp 1. Furthermore, the driving unit 4 is connected to a power supply 8, and features a signal input 18 to receive a target light flux Φ_{T}, for example a request to deliver a light flux of 4100 lm. Moreover, driving unit 4 comprises a signal output 19, for reporting, for example, the lamp status LS to a higher-level control unit.

The driving unit 4 comprises a buck converter 24, a commutation unit 25, an ignition arrangement 32, a level converter 35, a control unit 10, a voltage measuring unit 14, and a current measuring unit 12.

The control unit 10 controLs the buck converter 24, the commutation unit 25, and the ignition arrangement 32, and monitors the behaviour of the voltage at the gas discharge lamp 1.

The commutation unit 25 comprises a driver 26 which controls four switches 27, 28, 29, and 30. The ignition arrangement 32 comprises an ignition controller 31 (comprising, for example, a capacitor, a resistor and a spark gap) and an ignition transformer which generates, with the aid of two chokes 33, 34, a high voltage so that the gas discharge lamp 1 can ignite.

The buck converter 24 is fed by the external DC type power supply 8 of, for example, 380V. The buck converter 24 comprises a switch 20, a diode 21, an inductance 22 and a capacitor 23. The control unit 10 controls the switch 20 via a level converter 35, and thus also the current I in the gas discharge lamp 1. In this way, the electrical power P being provided to the gas discharge lamp 1 is regulated by the control unit 10.

The voltage measuring unit 14 is connected in parallel to the capacitor 23, and is realized in the form of a voltage divider with two resistors 16, 17. A capacitor 15 is connected in parallel to the resistor 17.

For voltage measurements, a reduced voltage is established by the voltage divider 16, 17, and measured in the control unit 10 by means of a voltage determination unit 40. The capacitor 15 serves to reduce high-frequency distortion in the measurement signal.

The current I in the gas discharge lamp 1 is monitored in the control unit 10 via input signal 39 by means of the current measuring unit 12, which might for example operate on the principle of induction. Based on the monitored current and the monitored voltage, the control unit 10 can calculate the electrical power P currently being provided to the gas discharge lamp 1 and adjust it via level converter 35 and switch 20, if the power level does exceed certain upper and/or lower limits.

Furthermore, the control unit 10 is implemented so that it is capable of supporting the first method according to the invention. To this end, control unit 10 comprises a correction factor determination unit 41, a power calculation unit 42, and a power control unit 43. The correction factor determination unit 41 receives a voltage value U_{L} from the voltage determination unit 40. In many cases, the voltage determination unit 40 would comprise an analogue/digital converter which measures the voltage across resistor 17 and generates a digital output value U_{L}, which represents the actual voltage across the gas discharge lamp. Therefore, the voltage determination unit 40 might also include a compensation for the fact that the measured voltage is reduced due to the voltage divider 16, 17. Additionally, the voltage value U_{L} might not represent the actual amplitude of the voltage across the gas discharge lamp 1, but rather be a voltage value averaged over time. For example, the voltage determination unit 40 might provide a root-mean-square (RMS) voltage value U_{L} to the correction factor determination unit 41.

Based on the voltage value U_{L}, the correction factor determination unit 41 determines a correction factor K_{d} which represents the dependency of the light flux Φ on the length of the discharge arc d of lamp 1. Here, the correction factor K_{d} is the result obtained from a correction function K_{d}(U_{L}) for a specific value of lamp voltage U_{L}, like for example the function described by equation (9). A correction factor determination unit 41 could be implemented by using a look-up table, as outlined above. The look-up table might be stored in a memory means, like a read-only memory (ROM) device or a re-writeable memory, for example a so-called flash memory.

The power calculation unit 42 receives the correction factor K_{d} from the correction factor determination unit 41 and also obtains a value for a target light flux Φ_{T} via signal input 18. If for example, a driving unit 4 according to the invention is used in a system with a user interface, the user of the system might want to control the light flux 1 delivered by the gas discharge lamp 1. Here, a user request, like “reduce light flux” would be delivered by the system to control unit 10 via signal input 18. Similarly, if the driving unit 4 is used in an image rendering system, the image rendering system might set a target light flux Φ_{T} via signal input 18 in accordance with the brightness of the image or video. For example, for darker scenes, the image rendering system would convey a lower target light flux value Φ_{T} to the control unit 10 via signal input 18. In another embodiment, the target light flux value Φ_{T} might simply be a constant value, like for illumination purposes, which do not need different levels of brightness, but do require a stable brightness. Based on the correction factor K_{d} and the target light flux value Φ_{T}, the power calculation unit calculates a required lamp power value P_{R} which is necessary to achieve the target light flux value Φ_{T}. In some cases, a power calculation unit 42 might perform only a relatively simple mathematical operation, like the division as given by equation (11).

General lamp driving units, as they are known to the experts of the technical field, are often operating the lamp according to a target power value instead of operating it according to a target light flux value Φ_{T}. Consequently, such driving units will not be able to deliver a constant flux of light, since the variations of the length of the discharge arc d are not taken into account. Hence, the driving unit 4 according to the invention is advantageous, as it drives the gas discharge lamp 1 such that a stable light flux Φ is achieved, due to the fact that the correction factor K_{d} depends on the length of the discharge arc d.

The required lamp power value P_{R} is submitted to the power control unit 43, which controls the level converter 35. Thereby, with the use of the voltage value U_{L} as derived by the voltage determination unit 40, the current I is set to a value such that the electrical power P delivered to the gas discharge lamp 1 meets the required lamp power value P_{R}. Accordingly, the lamp is operated at a lamp power level that ensures that the light flux Φ delivered from the gas discharge lamp 1 meets the target light flux value Φ_{T}.

The momentary lamp status LS of the gas discharge lamp 1 can be made known by the control unit 10 via the signal output 19. In particular, the lamp status LS can report whether the gas discharge lamp 1 actually delivers the target light flux Φ_{T}. Such status information might be obtained by the control unit 10 by simply comparing the actual lamp power value P with the required lamp power value P_{R}. If both values P, P_{R} arc essentially identical, the target light flux Φ_{T} has been achieved.

Even though control unit 10 comprises several units or modules 40, 41, 42, and 43, a practical realization of such a control unit 10 might implement one or more than one of the units 40, 41, 42, and 43 in a single unit. Particularly, the units 40, 41, and 42 might be realized within one unit which simply controls the level converter 35 based on the voltage value U_{L} derived by voltage determination unit 40. Such a single unit is often already present in existing driving units. Therefore, the embodiment of the methods according to the invention could mean, that only some kind of software module is updated to implement a power control scheme that takes into account the dependence of the light flux Φ on the length of the discharge arc d.

FIGS. 4a and 4b show measurement results for the collected light flux of a gas discharge lamp which is operated by a method according to the invention, by a driving unit 4 in accordance with the design principles depicted in FIG. 3. Comparing now FIG. 2b with FIG. 4b, it becomes obvious that the used method according to this invention can beneficially minimize the variations of the light flux caused by a changing length of the discharge arc. The remaining variations in FIG. 4b at voltages below 48V can be explained by the fact, that a mathematical approximation for equations (9) and (11) was used for those measurements. More complex approximations would lead to even smaller light flux variations. The larger variations seen between 48V and 49V are again explained by the slow response of the driver. Such behaviour could be avoided easily by a lamp power control that reacts more quickly to changes in the voltage across the gas discharge lamp. Then, the desired, very stable light flux can be achieved with the methods and driving units according to the invention even if an operating scheme, like the special scheme from WO 2005/062684 A1, is applied. Comparing now FIG. 2a with FIG. 4a, it can be seen that methods according to the invention largely improve the stability of the light flux. Instead of variations of more than 200 lm (i.e. more than 5%) as seen in FIG. 2a, the variations in FIG. 4a are below 50 lm, i.e. in the order of only 1%. The few measurement results for the collected light flux, which are above approximately 4100 lm are caused again by the slow driver response and could be avoided by applying a faster power control scheme.

FIG. 5 shows a gas discharge lamp 1 and a block diagram of a further possible realization of a driving unit 58 according to the second method of the invention. FIG. 5 comprises many of the various elements of FIG. 3, specifically the elements 1 to 40. Their functionality resembles the functionality of the elements 1 to 40 as described above in conjunction with the description of FIG. 3. In addition, FIG. 5 also shows a modified control unit 59, comprising beside the voltage determination unit 40, a pressure determination unit 51, a pressure calculation unit 52, and a pressure control unit 53. Additionally, FIG. 5 shows a signal output 54, a pressure adjusting unit 55, a pressure measurement unit 56, and a signal input 57. For this realization of a driving unit 58, an actual lamp pressure value p_{L} and lamp voltage value U_{L} are determined and used to calculate a lamp pressure value p_{R} which is required to achieve a target light flux Φ_{T} while taking into account the effect of variations of the discharge arc length d. To this end, the pressure measurement unit 56 obtains a parameter or a signal that allows to obtain at least an approximation of the actual pressure p_{L}, inside the gas discharge lamp 1. As outlined above, such a parameter could be the width of a certain spectral line, but other parameters and methods, like a direct pressure measurement via a pressure sensor, allowing to obtain a lamp pressure value p_{L}, might be used as well. The latter is performed within the pressure determination unit 51, which determines a lamp pressure value p_{L}, from the parameter or signal delivered from the pressure measurement unit 56 via signal input 57. Using this lamp pressure value p_{L}, together with the lamp voltage value U_{L} obtained by the voltage determination unit 40, the pressure calculation unit 52 determines a pressure value p_{R} which is required to achieve a target light flux Φ_{T}. Similar to FIG. 3, a target light flux Φ_{T} is provided via signal input 18. Again, Φ_{T} could be either constant or change over time. The pressure calculation unit 52 realizes directly or in an approximation the equations described above, like for example equation (18). Finally, the pressure control unit 53 is driving a pressure adjusting unit 55 via signal output 54 such that the pressure p_{L}, inside the gas discharge lamp essentially matches the required pressure value p_{R}. One example for such a pressure adjusting unit 55 could be a forced cooling means, like a fan or a ventilator. Obviously, in addition to the control of the lamp pressure p_{L}, driving unit 58 still provides the ability to control the current I provided to the gas discharge lamp 1. Such a control is for example required to dim the light flux for image rendering purposes as described above.

Although the present invention has been disclosed in the form of preferred embodiments and variations thereon, it will be understood that numerous additional modifications and variations could be made thereto without departing from the scope of the invention. Especially, combinations of the features of the different methods of this invention are possible. For example, the light flux of a gas discharge lamp might be controlled by adjusting the pressure of the lamp as well as the electrical power being supplied to the lamp. For the sake of clarity, it is also to be understood that the use of “a” or “an” throughout this application does not exclude a plurality, and “comprising” does not exclude other steps or elements. Also, a “unit” may comprise a number of blocks or devices, unless explicitly described as a single entity.

1. A method of driving a gas discharge lamp (1), wherein:
a value of voltage (UL) across the gas discharge lamp (1) is determined,
a correction function (Kd) representing the dependency of light flux (Φ) on a discharge arc length (d) is used to calculate a required lamp power value (PR) for a target light flux value (ΦT) by using the lamp voltage (UL),
the gas discharge lamp (1) is operated according to the required lamp power value (PR).

2. The method according to claim 1, wherein the discharge arc length (d) is given by a fraction, for which fraction the numerator is given by a subtraction of a lamp electrode fall value (Ufall) from the lamp voltage value (UL), and for which fraction the denominator is given by a lamp pressure dependent factor (ap).

3. The method according to claim 1, wherein the correction function (Kd) is proportional to an arc tangent of a function of the collecting etendue (E) and the arc discharge length (d).

4. The method according to claim 1, wherein the required power value (PR) is calculated by using a mathematical approximation, preferably an algebraic function of the lamp voltage value (UL).

5. The method according to claim 4, wherein the algebraic function is a polynomial function of the lamp voltage value (UL), preferably a 2nd order polynomial function.

6. The method according to claim 1, wherein the gas discharge lamp (1) is arranged in proximity to a light reflector and the required lamp power value (PR) is inversely proportional to a reflectivity value (ηrefl) of the light reflector.

7. A method for driving a gas discharge lamp (1), wherein:
a value of voltage (UL) across the gas discharge lamp (1) is determined,
a value of pressure (pL) inside the gas discharge lamp (1) is determined,
a correction function (Kp) representing the dependency of light flux (Φ) on a discharge arc length (d) is used to calculate a required lamp pressure value (pR) for a target light flux value (ΦT) by using the lamp voltage (UL) and the lamp pressure value (pL),
the gas discharge lamp (1) is operated according to the required lamp pressure value (pR).

8. The method according to claim 7, wherein the pressure (p) inside the gas discharge lamp (1) is controlled by means (55) capable of changing the temperature (TL) of the gas discharge lamp (1) such that the gas discharge lamp (1) is operated according to the required lamp pressure value (pR).

9. A driving unit (4) for driving a gas discharge lamp (1) comprising:
a voltage determination unit (40) for determining a value of lamp voltage (UL) across the gas discharge lamp (1),
a power calculation unit (42) for calculating a required lamp power value (PR) for a target light flux value (ΦT) using the lamp voltage value (UL) and a correction function (Kd), whereby the correction function (Kd) represents the dependency of light flux (Φ) on a discharge arc length (d),
a power control unit (43) driving the gas discharge lamp (1) according to the required lamp power value (PR).

10. A driving unit (58) for driving a gas discharge lamp (1) comprising:
a voltage determination unit (40) for determining a value of lamp voltage (UL) across the gas discharge lamp (1),
a pressure determination unit (51) for determining a value of pressure (pL) inside the gas discharge lamp (1),
a pressure calculation unit (52) for calculating a required lamp pressure value (pR) for a target light flux value (ΦT) using the lamp voltage value (UL), the lamp pressure value (pL), and a correction function (Kp), whereby the correction function (Kp) represents the dependency of light flux (Φ) on a discharge arc length (d),
a pressure control unit (53) controlling the pressure (pL) inside the gas discharge lamp (1) according to the required lamp pressure value (pR).

11. An image rendering system, particularly a projector system, comprising a driving unit (4, 58) according to claim 9, and a gas discharge lamp (1).
